(19) United States
(12) Patent Application Publication
(10) Pub. No.: US 2026/0245124 A1
(43) Pub. Date: Aug. 20, 2026

(54) IMPROVEMENTS TO MACHINE LEARNING SYSTEMS AND REAL ESTATE VALUATION USING CROWDSOURCED ESTIMATES WITH PROPERTY-DEPENDENT USER WEIGHTING AND AUTOMATED ATTRIBUTE DISCOVERY

(71) Applicant: Rexchange, LLC, New Orleans, LA (US)

(72) Inventors: John Benedict Tarantino, JR., New Orleans, LA (US); Aron Culotta, New Orleans, LA (US)

(73) Assignee: Rexchange, LLC, New Orleans, LA (US)

(21) Appl. No.: 19/641,929

(22) Filed: Apr. 8, 2026

Related U.S. Application Data
(63) Continuation-in-part of application No. 17/742,817, filed on May 12, 2022, now abandoned.

(51) Int. Cl. G06Q 30/0283; G06N 3/0455; G06Q 50/16

(52) U.S. Cl. CPC G06Q 30/0283; G06N 3/0455; G06Q 50/16

(57) ABSTRACT

A machine learning system and method for estimating real estate property sales prices by combining property attributes, contextual attributes, and crowdsourced user estimates in a closed-loop learning system. The system learns numeric representations for properties and users, and employs a modified weighting mechanism that incorporates property information into the value computation, enabling property-specific adjustment of user estimates based on learned user biases. Unlike standard weighting mechanisms that compute values solely from input source representations, the modified mechanism computes values from a combination of user representations, user price estimates, and property representations, enabling context-dependent corrections through a multi-layer transformation. A related method discovers new property attributes by identifying properties with similar attributes but different prices, collecting free-form natural-language feedback, clustering similar feedback using semantic analysis, and validating candidate attributes through quantitative backtesting.

### CROSS-REFERENCE TO RELATED APPLICATIONS

This application claims the benefit of U.S. Nonprovisional patent application Ser. No. 17/742,817 filed on May 12, 2022, the entire disclosure of which is hereby incorporated by reference in its entirety.

### FIELD OF THE INVENTION

The present invention relates to improvements in computer-implemented machine learning systems. More particularly, the present invention relates to a modified machine learning architecture that enables property-dependent weighting of crowdsourced user inputs for real estate valuation, including a modified weighting mechanism that departs from standard machine learning weighting approaches by incorporating information about the item being evaluated into the computation of each contributor's adjusted value, thereby enabling the machine learning model to learn and apply context-dependent corrections that standard weighting mechanisms cannot compute. The invention further relates to a method for automatically discovering new data attributes through analysis of crowdsourced feedback, semantic clustering, and quantitative validation.

### GENERAL BACKGROUND

In the field of machine learning, weighting mechanisms are used to combine multiple input signals into a single output. A weighting mechanism assigns a weight to each input signal, reflecting how much that signal should influence the output. One widely used form of weighting mechanism is the attention mechanism, which computes weights based on learned comparisons between a query (representing what the model is looking for) and keys (representing what each input signal offers). Attention mechanisms are core components of transformer architectures, which underlie modern artificial intelligence systems including large language models.

A limitation of standard weighting mechanisms, including standard attention mechanisms, is that the value computation, which determines the actual information each input signal contributes, is computed solely from the input signal itself, without incorporating information about the context of the query.

This architectural limitation creates a concrete technical problem in any application domain where the reliability of input sources varies depending on context. The mechanism can learn that a particular source is generally reliable or unreliable, but it cannot learn that a source is reliable in one context and unreliable in another, because the value computation does not incorporate contextual information.

The present invention addresses this limitation by modifying the value computation to incorporate both the input signal representations and the query representation. This modification enables the machine learning model to compute context-dependent corrections to input signals a capability that standard weighting mechanisms cannot provide. While the invention is described herein with reference to a real estate valuation application, the architectural modification to the weighting mechanism represents a technical improvement to the machine learning model itself that is not limited to any particular application domain.

### Application to Real Estate Valuation

Accurate estimation of real estate property values is a significant challenge. Property valuation affects numerous stakeholders, including buyers, sellers, lenders, insurers, and taxing authorities. Inaccurate valuations can lead to mispriced transactions, inappropriate lending decisions, and market inefficiencies. Conventional automated valuation models (AVMs) typically rely on statistical regression techniques applied to property attributes derived from sources such as real estate data feeds. These attributes may include square footage, number of bedrooms and bathrooms, lot size, year built, and geographic location. While such models provide baseline estimates, they suffer from several limitations.

First, conventional AVMs are limited to the attributes present in structured databases. Many factors that influence property value—such as curb appeal, neighborhood desirability, property condition, local market sentiment, flood risk, proximity to nuisances, socioeconomic trends, school quality, and street-level conditions—are not captured in standard real estate data feeds. These contextual attributes—factors that correlate with property value but are not intrinsic physical characteristics of the property itself—are often the very factors that experienced real estate professionals rely upon to differentiate their valuations from automated estimates. Second, conventional AVMs treat all data inputs uniformly and cannot adapt to varying reliability of different information sources or the contextual importance of property attributes. Third, conventional AVMs cannot incorporate human judgment and local market expertise in a systematic, scalable manner.

Some systems have attempted to incorporate crowdsourced estimates from multiple users. However, naive aggregation approaches, such as simple averaging, fail to account for the varying accuracy of different users across different property types. For example, a user who provides highly accurate estimates for luxury single-family homes may provide poor estimates for commercial properties or condominiums. Existing systems lack mechanisms to learn and apply such user-specific accuracy profiles in a property-dependent manner.

Furthermore, systems that attempt to learn user-specific weights typically treat each user's contribution as fixed regardless of the property being evaluated. Such systems cannot learn to adjust a user's contribution differently depending on the specific property, because the value computation does not incorporate property information.

There is therefore a need for improved machine learning architectures that can compute context-dependent weights and corrections for multiple input signals, accounting for the interaction between input sources and the query context. There is further a need for systems that can automatically discover new data attributes that affect prediction accuracy but are not present in standard databases.

### SUMMARY OF THE INVENTION

The present disclosure describes two inventions that may be used independently or in combination. The first invention is a machine learning system that combines property attribute data, contextual attribute data, and crowdsourced user estimates to generate property sales price predictions. The system ingests real estate data together with user estimation data into a closed-loop learning system that produces estimates that improve over time. The system learns numeric representations for both properties and users, and employs a modified weighting mechanism to decide how much to trust each user's estimate based on that user's past accuracy with similar properties. The system also learns how each user tends to be biased (for example, overestimating certain types of properties and underestimating others) and adjusts each user's estimate accordingly. The modified weighting mechanism departs from standard machine learning approaches by incorporating information about the property being valued into the computation of each user's adjusted value, enabling property-specific corrections that standard weighting mechanisms cannot compute.

The second invention is an attribute discovery system that identifies new property attributes affecting sales price by eliciting and analyzing crowdsourced feedback. The valuation system may operate without the attribute discovery system, and the attribute discovery system may identify and validate new attributes for use in any valuation model, including but not limited to the valuation system described herein.

The inventions described herein provide the following technical improvements to computer-implemented machine learning systems. These improvements are rooted in specific modifications to machine learning architecture and computational methods, and are not achievable by mental steps or by applying generic computing functions.

First, the modified weighting mechanism improves the functioning of the machine learning model itself by enabling context-dependent value computation. In a standard weighting mechanism, the value that each input source contributes is computed solely from the source's own representation; the context of the query does not influence the value computation. The present invention modifies the value computation to incorporate the query representation (the property being valued) alongside the source representations (the users providing estimates), enabling the model to learn and apply corrections that depend on the specific interaction between the source and the context. This is a modification to how the machine learning model computes its outputs, not merely the application of a known model to a new data domain.

Second, the multi-layer transformation in the value computation enables the model to learn nonlinear interaction patterns between users and properties. A single-layer transformation can only learn linear corrections. A multi-layer transformation with nonlinear activation functions can learn complex, property-dependent corrections. This is a technical capability improvement to the machine learning architecture.

Third, the computations required by the claimed methods, including high-dimensional matrix multiplications, nonlinear activation functions applied across hundreds or thousands of parameters simultaneously, gradient-based optimization of coupled weight matrices, and backpropagation through multi-layer transformations, are operations that cannot practically be performed in the human mind or with pen and paper. These are inherently computational operations that require the processing capabilities of a computer.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 is a block diagram illustrating a system architecture for real estate valuation using crowdsourced estimates according to an embodiment of the present invention.

FIG. 2 is a schematic diagram illustrating the machine learning architecture for the attention-based valuation model according to an embodiment of the present invention.

FIG. 3 is a flowchart illustrating a method for estimating a sales price of a real estate property using dynamically weighted crowdsourced inputs according to an embodiment of the present invention, according to an embodiment of the present invention.

FIG. 4 is a flowchart illustrating a method for discovering new property attributes through crowdsourced feedback according to an embodiment of the present invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the Figures, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

The following description sets forth numerous embodiments and parameters. It should be recognized, however, that such description is not intended as a limitation on the scope of the present invention but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein but is to be accorded a scope consistent with the claims.

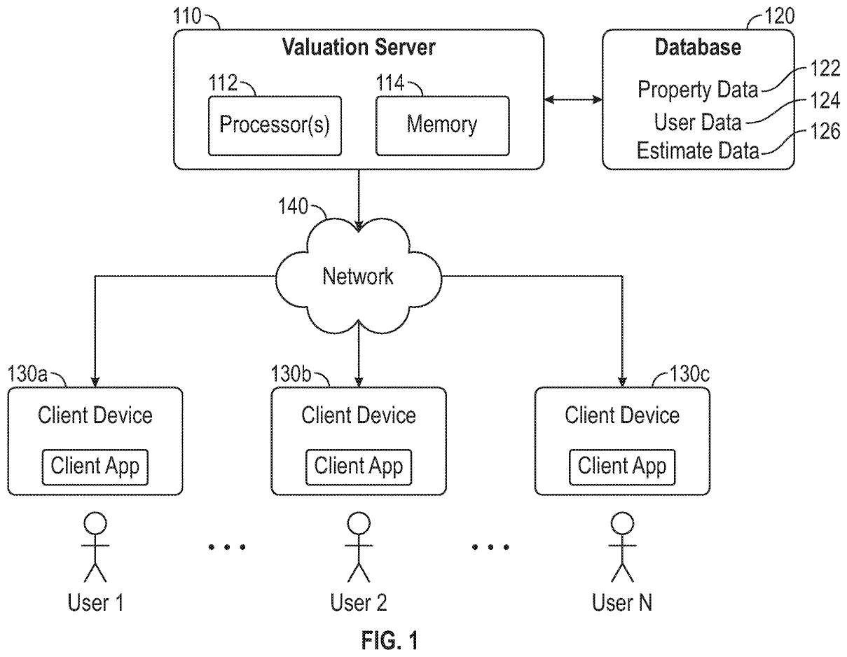

Referring now to FIG. 1, a system 100 for real estate valuation using crowdsourced estimates is illustrated according to an embodiment of the present invention. The system 100 comprises a valuation server 110, a database 120, and a plurality of client devices 130a, 130b, 130c. The valuation server 110 is in communication with the database 120 and the client devices 130a-c via a network 140, which may comprise the Internet, a local area network, a wireless network, or any suitable combination thereof.

The valuation server 110 comprises one or more processors 112 and a memory 114 storing instructions that, when executed by the processors 112, cause the valuation server 110 to perform the methods described herein. The valuation server 110 may be implemented as a single server, a cluster of servers, a cloud-based computing infrastructure, or any other suitable computing arrangement. In some embodiments, the valuation server 110 may comprise specialized hardware accelerators configured to accelerate machine learning computations.

The database 120 stores property data 122, user data 124, estimate data 126, and model parameters 128. The property data 122 includes property attribute vectors for properties that are listed for sale, have been sold, or are expected to be listed. The property attributes are obtained from real estate data feeds and from other data sources providing contextual attributes as described herein. The user data 124 includes user account information and learned user representations. The estimate data 126 includes historical records of user-provided price estimates and corresponding actual sales prices. The model parameters include the trained parameters for the machine learning model, including weight matrices and bias vectors.

Each client device 130a-c executes a client application that enables users to view property listings, submit price estimates, provide attribute feedback, and receive valuation predictions. The client devices 130a-c may comprise smartphones, tablets, desktop computers, or other computing devices. The client application communicates with the valuation server 110 via application programming interfaces (APIs) to submit user estimates and retrieve valuation predictions.

### Data Flow

The data flow for generating a property valuation estimate proceeds as follows. First, a valuation request is transmitted to the valuation server, where the request includes or references a property identifier. Second, the valuation server retrieves the property attributes and contextual attributes for the identified property from the database. Third, the valuation server retrieves one or more user estimates for the identified property. Fourth, the valuation server provides the property attributes, contextual attributes, and user estimates as inputs to the machine learning model. Fifth, the machine learning model processes the inputs and produces a final estimate of the property sales price. Sixth, the valuation server transmits the final estimate to the requesting client application.

### Property Attributes and Contextual Attributes

Each property is associated with a property attribute vector comprising one or more attributes obtained from multiple data sources. The attributes fall into two functional categories: property attributes and contextual attributes.

Property attributes are characteristics that describe the physical property itself or its listing status. In exemplary embodiments, property attributes are obtained from real estate data feeds, such as the multiple listings services, and include, but are not limited to: ZIP code, street address, list date, approximate living area (in square feet), approximate total square footage, property condition, number of bedrooms, total number of bathrooms, number of full bathrooms, number of half bathrooms, days on market, car storage capacity (garage spaces), number of stories, construction materials, foundation type, fencing type, pool type, latitude, and longitude.

Contextual attributes are characteristics that correlate with property value but are not intrinsic physical characteristics of the property itself. Contextual attributes capture environmental, neighborhood, socioeconomic, and street-level conditions that experienced real estate professionals commonly consider in their valuations but that are not present in standard real estate data feeds. In exemplary embodiments, contextual attributes include, but are not limited to: flood zone grade, school zone quality, crime zone grade, walkability score, proximity to commercial districts, neighborhood condition assessments, street flooding risk, proximity to nuisances, local market trend indicators, and socioeconomic indicators for the surrounding area.

In exemplary embodiments, the contextual attributes collected by the system include, but are not limited to, attributes in the following categories. These contextual attributes may collected through structured forms completed by property sellers and their listing agents, as described further below, and through automated data retrieval from external sources. The following list is illustrative and not exhaustive; the system is designed to incorporate additional contextual attributes over time through the attribute discovery process described herein.

Property Basics: overall property condition (rated on a scale such as excellent, very good, average, fair, or poor); interior condition; exterior condition; lot condition; whether the property is situated on a corner lot; number of stories; property architectural style (such as traditional, modern, contemporary, colonial, ranch, craftsman, Mediterranean, or other); presence of a basement and whether it is finished, together with its condition; and presence of an attic and whether it is finished, together with its condition.

Exterior and Structure: foundation type (such as raised, slab, basement, crawl space, pier and beam, or other) and condition; siding material (such as wood, hardy board, asbestos tile, stucco, aluminum, vinyl, brick, or other) and condition; roof style (such as shingle, sheet metal, flat, tile, slate, or other), roof age, whether the roof is fortified rated, and roof condition; exterior color and paint condition; availability and type of off-street parking; driveway surface material and condition; availability of street parking and typical number of spaces available; and street condition.

Interior Finishes: main flooring type (such as real hardwood, engineered hardwood, tile, carpet, vinyl, laminate, or other) and condition; interior paint color and condition; kitchen countertop material (such as marble, granite, quartz, quartzite, formica, butcher block, polished concrete, or other) and condition; kitchen cabinet color, condition, and whether cabinets have soft-close hardware.

Appliances: presence, type, and condition of stove (including gas or electric type and presence of a range hood); presence and condition of refrigerator; presence and condition of dishwasher; presence and condition of microwave; presence and condition of separate freezer unit; presence of washer and dryer hookups; presence and condition of washer and dryer; presence and room-by-room location of ceiling fans (such as living room, dining room, primary bedroom, secondary bedrooms, or other rooms); and presence and room-by-room location of recessed lighting.

Building Systems: quality tier and condition of electrical fixtures (such as high end, mid level, contractor grade, or budget basic); quality tier and condition of plumbing fixtures; air conditioning type (such as central, window unit, mini-split, or none), age, and energy efficiency rating; and hot water heater type (such as gas, electric, or tankless), age, and energy efficiency rating.

Doors, Windows, and Outdoor Features: interior door construction (solid or hollow core) and condition; window frame material (such as wood, plastic, aluminum, or other), condition, energy efficiency rating, and style; presence, condition, and operability of shutters; presence, flooring material, and railing material of balconies (front, side, and rear); presence, flooring material, railing material, lighting, and fan presence for porches (front, side, and rear).

Yard, Garden, and Pool: presence and condition of front, side, and rear yards, including surface type (such as paved, gravel, grass, pods or tiles, dirt, or other); presence and condition of garden areas; presence and type of pool (in-ground or above-ground), pool condition, pool size, and pool deck material.

Environment and Market Conditions: surrounding street condition; whether the street is prone to flooding and the rainfall intensity threshold at which flooding occurs (such as light, moderate, heavy, or major storm); type and condition of neighboring properties to the left, right, behind, and directly across from the subject property (such as single family, multifamily, vacant lot, or commercial), including whether neighboring properties exhibit signs of blight or abandonment; cost of property insurance; and proximity to significant events or event venues.

Agent-Assessed Attributes: interior smell assessment (such as noxious, odorous, or normal) and identified source of smell; and exterior smell assessment and identified source of smell. Agent-assessed attributes are collected by the listing agent during an in-person property visit and serve as a validation and correction of seller-reported attribute data, as described below.

Automatically Retrieved Attributes: public school quality rankings; private school quality rankings; neighborhood crime rankings; walkability scores; and public transportation accessibility scores. In some embodiments, these attributes are automatically retrieved from third-party data sources or computed from publicly available data.

In preferred embodiments, further contextual attribute data may be collected through a form input process designed to improve data accuracy. When a property seller engages a real estate agency to list a property, the seller is provided access to a form comprising fields for each of the contextual attributes listed above and an option to provide additional contextual attributes. The seller completes the form based on the seller's knowledge of the property. The listing agent independently completes the same structured form either during an in-person or virtual visit to the property or after the visit to the property. The system receives both the seller-reported contextual attributes and the agent-reported contextual attributes. Because property sellers may exhibit bias toward overestimating the condition and desirability of their own properties, the agent's independent assessment serves as a correction mechanism. In some embodiments, the system may use both sets of attribute values as separate inputs to the machine learning model, enabling the model to learn the informational value of each source. In other embodiments, the system may apply a process to produce a single set of contextual attribute values from the two inputs. The collected contextual attribute data may then incorporated into the property attribute vector for use in the valuation model described herein, and may also be used to generate a property report for the listing agent that reflects the validated contextual attributes.

In some embodiments, the collection process may be extended to the buyer's side of a transaction. A buyer's agent visiting a property prior to showing it to a prospective buyer may independently complete the contextual attribute form. The buyer's agent's attribute assessments may be used by the system to compute a more informed estimate of an appropriate offer price, reflecting the buyer's agent's independent observation of property conditions.

In some embodiments, the system may also incorporate attributes derived from additional data sources, including but not limited to public records, geographic information systems (GIS), census data, environmental databases, satellite imagery analysis, and user-generated content. The system is not limited to any fixed set of attributes and is designed to accommodate the addition of new attributes through the attribute discovery process described herein and through integration with new data sources as they become available.

In addition to influencing predicted sales price, contextual attributes and property attributes as described herein may also be used by the system to assess the general marketability or attractiveness of a real estate property. In real estate markets, the number of days a property remains on market is influenced by a combination of factors, including listing price relative to fair market value, property condition, and the contextual attributes described above. After a threshold number of days on market, real estate agents and sellers commonly withdraw properties from active listing and relist them at a later date, often at a reduced price. The system described herein may compute, using the same machine learning architecture and attribute data, a predicted days-on-market value or a marketability score for a property, in addition to a predicted sales price. Such a prediction enables real estate agents and agencies to assess, prior to accepting a listing, whether a property is likely to sell within a certain timeframe given the seller's asking price and the property's contextual attributes. This provides a practical benefit to real estate agencies, which incur costs in the form of professional photography, property visits, staging, open houses, and marketing expenses each time a property is listed. By providing a quantitative assessment of marketability informed by contextual attributes that are not available in conventional automated valuation models, the system enables agents to make better-informed decisions about which listings to accept and how to advise sellers on pricing strategy. In some embodiments, the marketability prediction may be derived from the same property representation and contextual attribute data used by the valuation model, leveraging the learned relationships between property attributes, contextual attributes, and historical market outcomes, including historical days-on-market data for comparable properties in the training dataset.

For the purposes of this specification, the terms “property attributes” and “contextual attributes” are used to distinguish these functional categories. However, in the machine learning model, all attributes are combined into a single property attribute vector and processed uniformly. The number and type of attributes may vary across embodiments and may change over time as new data sources and attribute types are incorporated.

### Preprocessing

Prior to input to the machine learning model, the property attributes may undergo preprocessing transformations to normalize the data and convert all attributes to a numeric format suitable for model processing. The specific preprocessing transformations may vary across embodiments. In some embodiments, continuous attributes (numeric values that can take any value within a range, such as square footage or number of bedrooms) are standardized using z-score normalization, wherein each value is transformed by subtracting the mean and dividing by the standard deviation computed from the training data. In other embodiments, other suitable normalization techniques may be used. In some embodiments, categorical attributes (discrete values selected from a finite set of options, such as ZIP code or construction materials) are converted to numeric format using one-hot encoding, wherein each categorical attribute is replaced by a binary vector with a one in the position corresponding to the category value and zeros in all other positions. In other embodiments, other suitable encoding techniques may be used.

In some embodiments, continuous values with skewed distributions will be transformed with a logarithmic transformation, wherein each value is transformed by applying the log function to it.

After preprocessing, the continuous and categorical attributes are combined to form the final property attribute vector by concatenating the values into a single vector. The dimensionality of this vector depends on the number and encoding of the attributes used.

### Machine Learning Architecture Overview

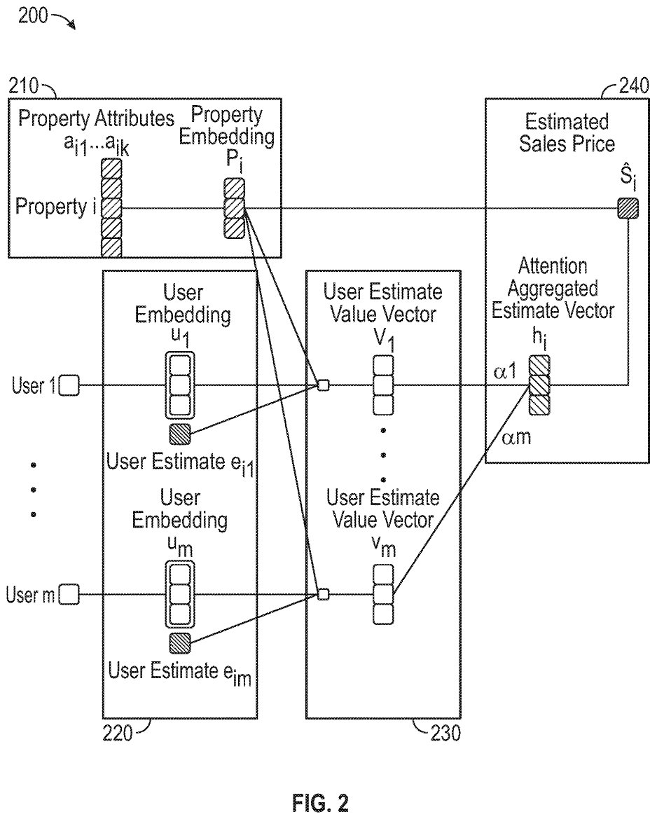

Referring now to FIG. 2, the machine learning architecture 200 is illustrated. The machine learning model receives as input a preprocessed property attribute vector and a set of user estimates for the property and produces as output an estimated sales price for the property. The model is trained on historical data comprising properties for which both user estimates and actual sales prices are known. Once trained, the model can be applied to new properties to generate valuation predictions.

The machine learning model comprises a property representation module 210, a user representation module 220, a weighting module 230, and an output module 240. In preferred embodiments, the model is implemented as a neural network. In more preferred embodiments, the model is implemented as an attention-based neural network. However, the principles of the modified weighting mechanism described herein (incorporating the query representation into the value computation) may be applied to other machine learning architectures as well.

### Property Representation Module

The property representation module 210 transforms the preprocessed property attribute vector into a compact numeric representation of the property. This transformation compresses the high-dimensional attribute vector into a lower-dimensional representation that captures the salient features of the property for purposes of valuation. In machine learning, such compact numeric representations are commonly referred to as “embedding vectors.” In some embodiments, the transformation comprises a weight matrix multiplication followed by a nonlinear activation function. The nonlinear activation function enables the model to capture complex, nonlinear relationships between property attributes. In preferred embodiments, the activation function is ReLU (Rectified Linear Unit), defined as ReLU(x)=max(0, x), applied element-wise. In other embodiments, other suitable nonlinear activation functions may be used. The dimensionality of the representation (commonly referred to as the “embedding dimension”) is a configurable parameter. In some embodiments, the dimensionality may take values such as 64, 128, or 256, though other values may be used.

### User Representation Module

The user representation module 220 produces a numeric representation for each user who provided an estimate for the property. Each user's representation encodes information about that user's estimation patterns, accuracy, and biases, as learned from historical data. Over time, as a user provides more estimates and actual sales prices become known, the system refines its representation of that user, capturing that user's demonstrated expertise across different property types, geographic areas, and price ranges.

In some embodiments, each user is represented by a stored numeric vector obtained by looking up the user's identifier in a table of learned representations. This lookup operation is equivalent to multiplying a one-hot encoded vector (a vector of zeros with a one at the position corresponding to the user's index) by a learned matrix. For new users who have not yet provided sufficient estimates for the system to learn an accurate representation, a default representation may be used, such as the average of all user representations.

### Weighting Module: Modified Weighting Mechanism

The weighting module 230 computes weights that determine how much influence each user's estimate should have on the final prediction. The weighting module also computes adjusted values for each user's contribution that account for that user's accuracy patterns for properties of the type being evaluated.

The weighting module computes three types of intermediate values, which in the context of attention-based models are referred to as a query, keys, and values. The query is derived from the property representation and represents the features that the model is seeking in user estimates for this particular property. The keys are derived from the user representations and user estimates and represent what each user offers for matching against the query. The values represent the actual adjusted information that each user contributes.

Standard approach (prior art): In a standard weighting mechanism, the values are computed solely from the user representations and user estimates, without incorporating information about the property being valued. Mathematically, in standard attention: V=W_v*[U, e], where U represents the user representations, e represents the user estimates, and W_v is a learned weight matrix. Under this formulation, each user's value contribution is the same regardless of which property is being evaluated. The query influences only the weights (how much to trust each user), not the values (what each user actually contributes). This means the mechanism cannot learn to adjust a user's estimate differently depending on the specific property being valued.

Modified approach (present invention): The present invention modifies the value computation to incorporate the property representation alongside the user representations and user estimates. This modification enables the model to treat users differently depending on the property profile, for example, applying a larger correction to a user's estimate for properties in one geographic area than for properties in another. In some embodiments, the values are computed by applying a multi-layer transformation to a combined input comprising the user representations, the user estimates, and the property representation. In preferred embodiments, the multi-layer transformation comprises at least two layers with a nonlinear activation function between them.

The use of multiple layers in the value computation provides a critical technical advantage: it enables the model to learn nonlinear, property-dependent corrections to user estimates. With only a single layer (a single weight matrix), the model could only apply linear transformations to the combined input. This would limit the model to corrections that scale proportionally, for example, “this user always overestimates by a fixed percentage.” A multi-layer architecture with nonlinear activation functions enables the model to learn complex interaction patterns between user profiles and property characteristics, for example, “this user overestimates by 10 percent for properties in one ZIP code but underestimates by 5 percent for properties in another ZIP code, and this pattern varies further by price range.” These complex correction patterns arise from the composition of nonlinear functions across layers, which is a well-understood property of multi-layer neural networks that cannot be replicated by a single linear transformation.

The weights for each user are computed by comparing the query to the keys and normalizing the results so that the weights sum to one. In preferred embodiments, the weights are computed using scaled dot-product comparison followed by softmax normalization.

The combined estimate is computed as a weighted sum of the values, where each value is weighted by the corresponding weight. The combined estimate represents a consensus that gives more weight to users whose representations match well with the property representation, with each user's contribution adjusted based on learned property-specific correction factors.

### Output Module

The output module 240 combines the weighted user estimates with the property representation to produce the final sales price estimate. In some embodiments, the aggregated estimate and property representation are concatenated and passed through a transformation comprising one or more weight matrix multiplications and nonlinear activation functions, followed by a final linear transformation to produce a scalar output representing the estimated sales price.

### Preferred Embodiments—Mathematical Formula

The following describes preferred embodiments of the neural network architecture using specific mathematical notation. Those skilled in the art will recognize that various modifications to the specific formulations may be made without departing from the scope of the invention.

In the preferred embodiment, consider a property that is either currently listed for sale or is expected to be listed soon. Let the property be denoted as property “i”. Property “i” has a set of “k” attributes, denoted aᵢ₁, aᵢ₂, . . . , aᵢₖ. The property attribute vector is denoted “aᵢ”, which is an element of R^{k} (the set of real-valued vectors of dimension k), where “k” is the number of property attributes after preprocessing.

Variable eᵢⱼ denotes the estimate provided by user “j” for the future sales price of property “i”. Each property “i” has estimates provided by up to “m” users, denoted eᵢ₁, eᵢ₂, . . . , eᵢₘ, where “m” is the maximum number of users in the system. Let sᵢ denote the eventual, observed sales price of property “i”.

The goal of the system is to produce an estimated sales price, denoted ŝᵢ, for property “i”. This estimate is based on property attributes aᵢ₁, . . . , aᵢₖ as well as user estimates eᵢ₁, . . . , eᵢₘ. The estimate ŝᵢ should be as accurate as possible, as measured by its deviation from the observed sales price sᵢ.

### Preferred Embodiment—Property Representation Computation

In some embodiments, the property representation (specifically, the property embedding vector pᵢ) is computed by transforming the property attributes through a neural network layer. Specifically, the property embedding vector pᵢ is computed according to the following formula: pᵢ=ReLU(Wₚ^{T}*aᵢ+bₚ). In this formula, Wₚ is a learned property weight matrix of dimension “k” by “d”. The term bₚ is a bias vector of dimension “d”. ReLU is defined as ReLU(x)=max(0, x), applied element-wise.

### Preferred Embodiment—User Representation Computation

In some embodiments, each user is represented by a learned numeric vector that captures their estimation patterns and biases. Specifically, each user “j” is represented initially by a one-hot encoded vector xⱼ∈R^{m}, (i.e. xⱼ is an element of R^{m}), where “m” is the maximum number of users in the system. The vector xⱼ is a vector of zeros with a 1 at location “j” to represent user “j”. Each user “j” is transformed to a user representation (specifically, a user embedding vector uⱼ) by looking up their entry in a table of learned user representations. The user embedding matrix U∈R\hat{ }(m×d) is formed by stacking each user embedding uⱼ as rows in a single matrix. Specifically, uⱼ is computed by multiplying xⱼ by the user weight matrix Wᵤ∈R^{m×d}.

### Preferred Embodiment—Weighting Mechanism: Query, Key, and Value Computation

In some embodiments, the weighting mechanism for this model requires three types of intermediate computations: a query, keys, and values. In the preferred embodiment, these correspond to the query matrix Q, key matrix K, and value matrix V used in attention mechanisms.

The query represents what the model is looking for based on the property. The query is computed by transforming the property representation using a learned weight matrix. Specifically, the query matrix Q is computed by multiplying the property embedding pᵢ by the query weight matrix W_{Q}∈R^{d×d}.

The keys represent what each user offers for comparison against the query. The keys are computed by combining each user's representation with their price estimate and transforming the result. Specifically, the key matrix K is computed by first concatenating the user matrix U with the vector e=[eᵢ₁, eᵢ₂, . . . , eᵢₘ] representing the vector of all price estimates from the “m” users. The resulting matrix [U e] has dimension m by (d+1). This concatenated matrix is then multiplied by the key weight matrix W_{K}∈R^{d×d+1}.

The values represent the adjusted contribution from each user, accounting for that user's accuracy patterns for properties of this type. The value computation deviates from standard approaches by incorporating the property representation along with the user representation and estimate. To ensure that the model is able to adjust a user's estimate based on their accuracy for certain types of properties, the value computation combines the user representations, the user's price estimates, and the property representation. To compute the value matrix V, the model first concatenates the user representation matrix U (dimension “m” by “d”), the price estimate vector e (dimension “m” by 1), and the property representation vector pᵢ (replicated across all “m” rows, contributing “d” values per row). This produces a matrix [U e pᵢ^{T}] with dimension “m” by (2d+1): “d” values from the user representation, 1 value from the price estimate, and “d” values from the property representation, totaling 2d+1 values per row.

This concatenated matrix is then passed through a two-layer transformation that enables nonlinear, property-dependent corrections. Specifically, the matrix is multiplied by the first value weight matrix Wᵥ₁, which has dimension (2d+1) by d: it has (2d+1) rows to accept the concatenated input, and “d” columns to produce a d-dimensional intermediate representation. The result is passed through a nonlinear activation function (ReLU) and then multiplied by the second value weight matrix Wᵥ₂, which has dimension “d” by “d”.

The use of two weight matrices Wᵥ₁ and Wᵥ₂ enables the model to flexibly capture nonlinear interactions between user and property profiles, which is key to adjusting user estimates in a property-specific manner. For example, the model can learn that a particular user tends to overestimate prices by 10 percent for properties in one ZIP code but underestimate by 5 percent for properties in another ZIP code.

### Preferred Embodiment—Weight Computation

The weight for each user is computed by comparing the query to the keys and normalizing the results so the weights sum to one. Specifically, the attention weights α=[α₁, α₂, . . . αₘ], one per user, are computed by taking the dot product of each key with the query, scaling the result, and applying a normalization function. Each αⱼ is in the range [0, 1] and the weights sum to 1. The model computes:

$$α = softmax ( \frac{K Q}{\sqrt{d}} ) ,$$

where \sqrt{d} is the square root of the representation dimensionality d.

### Preferred Embodiment—Aggregated Estimate Computation

In some embodiments, the combined estimate from all users is computed as a weighted sum of the value vectors, where each user's value is weighted by that user's weight. Specifically, the attention-aggregated estimate vector h; is computed as: hᵢ=α^{T}V. The vector hᵢ∈R^{d}, represents the estimated valuation of the property based on a combination of user estimates, inclusive of adjustments made based on each user's strengths and weaknesses for properties of this type.

### Preferred Embodiment—Final Output Computation

In some embodiments, the attention-aggregated values h; are concatenated to the original property embedding pᵢ and passed through a two-layer network to produce the final price estimate. The concatenated vector [hᵢ pᵢ] is multiplied by the output matrix Wₒ ∈R^{d×2d}. (Formally: ŝᵢ=w^{T}ReLU(Wₒ[hᵢ pᵢ]+b)+c.)

### Summary of Model Parameters

In some embodiments, the full list of learned model parameters and their dimensionality may be as follows. Key factors influencing the number of parameters are: d (the dimension of representation vectors, typically 64, 128, or 256), m (the maximum number of users), and k (the number of property attributes after preprocessing).

The property transformation matrix Wₚ (specifically, the property embedding matrix) has dimension “k” by “d”. The user representation table Wᵤ(specifically, the user embedding matrix) has dimension “m” by “d”. The query weight matrix W_{Q} has dimension “d” by “d.” The key weight matrix W_{K} has dimension (d+1) by d. The first value weight matrix Wᵥ₁ has dimension (2d+1) by “d.” The second value weight matrix Wᵥ₂ has dimension “d” by “d.” The output weight matrix Wₒ has dimension “d” by “2d.” The output weight vector “w” has dimension “d.”

For example, a model where d=64, m=100, and k=50 would have: (50×64)+(100×64)+(64×64)+(65×64)+(129×64)+(64×64)+(64×128)+64=3,200+6,400+4,096+4,160+8,256+4,096+8,192+64=38,464 parameters (excluding bias terms).

### Model Training

The training process adjusts the model parameters to minimize the difference between predicted sales prices and actual sales prices on historical data. This process involves gradient-based optimization, wherein the model parameters are iteratively adjusted in the direction that reduces prediction error.

The training data comprises historical records of properties for which both user estimates and actual sales prices are available. Each training example includes a property attribute vector (including both property attributes and contextual attributes), a set of user estimates, and the actual sales price. The training data is divided into a training set, a validation set, and a test set.

The model parameters are initialized using standard initialization techniques. The model is trained using gradient-based optimization with a suitable optimization algorithm. At each training iteration, a mini-batch of training examples is sampled, the forward pass is computed, the loss is computed, and the gradients are computed and used to update the model parameters via backpropagation. Backpropagation involves computing partial derivatives of the loss function with respect to each model parameter by applying the chain rule of calculus backward through the model's computational graph an operation that requires tracking dependencies across thousands of parameters simultaneously.

The parameters are optimized using stochastic gradient descent. In some embodiments, Adaptive Moment Estimation (Adam) or Adam with Weight Decay (AdamW) optimizers will be used, which use adaptive learning rates to improve generalization and stability.

The loss function measures the discrepancy between predicted and actual sales prices. In some embodiments, the loss function is mean squared error (MSE). In other embodiments, the loss function may be mean absolute error (MAE) or Huber loss. The optimal choice is determined based on validation performance.

Model hyperparameters are tuned using the validation set. The hyperparameters include the learning rate, batch size, representation dimensionality d, dropout rate (to reduce overfitting), and number of training epochs.

The learned user representations provide a technical advantage in terms of data efficiency. Because the model learns to represent users in a shared representation space, it can pool information across users during training. This information pooling reduces the amount of training data required to learn accurate user profiles compared to approaches that treat each user independently.

The learned weighting mechanism provides inherent robustness to noisy and adversarial inputs. Because the weights are computed based on learned comparisons between user representations and the property representation, users who consistently provide inaccurate or unreliable estimates will, over the course of training, develop user representations that produce low weights across properties. This occurs without the need for explicit outlier detection or filtering rules: the model learns to disregard unreliable users as a consequence of optimizing prediction accuracy on the training data.

Similarly, the system is robust to attempts to manipulate or “game” the valuation by submitting intentionally biased estimates. An adversarial user whose estimates systematically deviate from actual sales prices will develop a user representation that reflects this pattern. When the model computes weights for a new property, the adversarial user's representation will produce a low weight, limiting the adversarial user's influence on the final estimate. Furthermore, the modified value computation can learn to apply corrections that counteract systematic biases in a user's estimates, further reducing the impact of adversarial behavior.

This architectural robustness is distinct from rule-based filtering approaches that discard estimates based on predefined thresholds (such as discarding estimates beyond a fixed number of standard deviations from a mean). Rule-based filtering requires the system designer to anticipate the forms of noise or adversarial behavior and design rules accordingly. The learned weighting mechanism adapts to patterns of unreliability in the data without requiring such anticipation.

### Closed-Loop Learning System

The system operates as a closed-loop learning system. As new properties are sold and actual sales prices become available, the system continuously acquires new training data. This new data is used to periodically retrain or incrementally update the model, refining the user representations to reflect each user's evolving demonstrated expertise. The closed-loop nature of the system means that estimates improve over time as more data becomes available, users refine their skills, and new attributes are discovered and incorporated. Because real estate markets change over time and user expertise may evolve, the system is configured to periodically retrain or incrementally update the model as new training data becomes available. When a property that was previously valued by users is subsequently sold, the actual sales price becomes available and is incorporated into the training dataset. Periodic retraining causes the learned user representations to reflect each user's most recent demonstrated accuracy patterns, naturally reducing the influence of outdated performance data without requiring explicit temporal decay functions or freshness weights. Because real estate markets change over time and user expertise may evolve, the system is configured to periodically retrain or incrementally update the model as new training data becomes available. When a property that was previously valued by users is subsequently sold, the actual sales price becomes available and is incorporated into the training dataset. Periodic retraining causes the learned user representations to reflect each user's most recent demonstrated accuracy patterns, naturally reducing the influence of outdated performance data without requiring explicit temporal decay functions or freshness weights.

Validation data is used to optimize certain parameters of the retraining procedure, including, but not limited to, the number of iterations of retraining, the time frame of training data used, and any time-dependent weight decay parameter to reduce the importance of training instances based on age.

Interpreting User Quality from Weights

After the model has been trained, the computed weights can be inspected to assess the importance of each user's estimate to the model's final prediction. Higher weights indicate that the user's estimate played a larger role in the prediction. The system can compute the importance of a user across all data by aggregating their weights for all properties. Similarly, the system can compute a user's importance for properties with a selected attribute by aggregating weights across all properties with that attribute. This enables the system to identify users who have demonstrated expertise in specific property types, geographic areas, or price ranges.

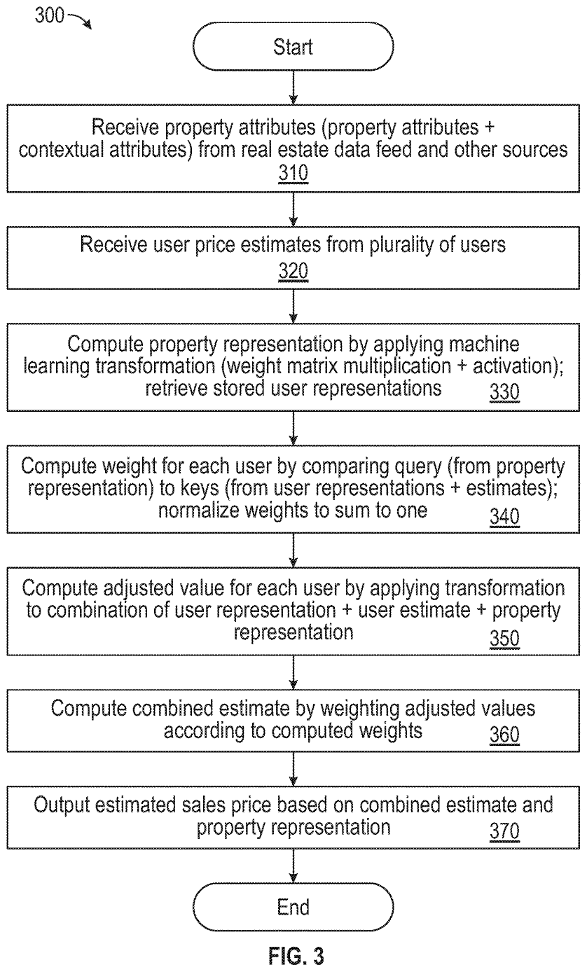

Referring now to FIG. 3, a method 300 for estimating a sales price of a real estate property using dynamically weighted crowdsourced inputs is illustrated according to an embodiment of the present invention. The method 300 is performed by the valuation server 110 (FIG. 1) executing the machine learning model described with reference to FIG. 2. The method 300 proceeds through steps 310 through 370 as described below.

At step 310, the one or more processors receive property attributes and contextual attributes for a real estate property. The property attributes include property attributes obtained from a real estate data feed (such as Multiple Listing Service data) and contextual attributes representing factors that correlate with property value but are not intrinsic physical characteristics of the property, as described with reference to the property attributes and contextual attributes sections above. In some embodiments, the property attributes undergo preprocessing comprising normalization of continuous attributes and numeric encoding of categorical attributes to produce a property attribute vector suitable for input to the machine learning model, as described with reference to the preprocessing section above.

At step 320, the one or more processors receive user price estimates for the property from a plurality of users. Each user price estimate is a scalar value representing that user's estimate of the future sales price of the property, entered by the user through a client application executed on a client device 130 (FIG. 1). The user price estimates are denoted eᵢ₁, eᵢ₂, . . . , eᵢₘ, where m is the number of users who have provided estimates for the property.

At step 330, the one or more processors compute a property representation and retrieve user representations. The property representation is computed by the property representation module 210 (FIG. 2), which applies a machine learning transformation comprising at least a weight matrix multiplication to the property attribute vector. In preferred embodiments, the property representation is the property embedding vector pᵢ computed according to the formulation described in the mathematical specification section above. The user representation for each user is retrieved from a stored user representation data structure by the user representation module 220 (FIG. 2). Each user representation is a learned embedding vector that encodes that user's historical estimation patterns, as learned from training data comprising prior user estimates and corresponding actual sales prices. In preferred embodiments, the user representations are rows of the learned user embedding matrix U described in the mathematical specification section above.

At step 340, the one or more processors compute a weight for each user. The weights are computed by the weighting module 230 (FIG. 2) by comparing a query derived from the property representation to keys derived from the user representations and user price estimates, and normalizing the comparison results such that the weights sum to one. The query represents which features the model is looking for regarding this particular property; the keys represent what each user offers for comparison against the query. In preferred embodiments, the query, keys, and weights are computed according to the Q, K, and a formulations described in the mathematical specification section above, using scaled dot-product comparison and softmax normalization.

At step 350, the one or more processors compute an adjusted value for each user. The adjusted values are computed by the weighting module 230 (FIG. 2) by applying a transformation to a combination of that user's representation, that user's price estimate, and the property representation. The incorporation of the property representation into the value computation is the modification that distinguishes the present method from standard weighting approaches: it enables property-specific adjustment of user estimates that is not achievable by a value computation that operates solely on user representations. In preferred embodiments, the adjusted values are computed according to the V formulation described in the mathematical specification section above, using a multi-layer transformation with a nonlinear activation function between layers.

At step 360, the one or more processors compute a combined estimate by weighting the adjusted values according to the weights computed at step 340. Each user's adjusted value vector is multiplied by that user's weight, and the results are summed to produce an aggregated estimate vector. In preferred embodiments, the aggregated estimate vector h; is computed as described in the mathematical specification section above.

At step 370, the one or more processors output an estimated sales price based on the combined estimate and the property representation. The estimated sales price is computed by the output module 240 (FIG. 2), which applies a transformation to a combination of the aggregated estimate vector and the property representation to produce a scalar sales price estimate. In preferred embodiments, the estimated sales price s; is computed according to the output formulation described in the mathematical specification section above.

The method 300 may be repeated for each property for which a valuation is requested. Because the trained model computes the estimated sales price through a single forward pass of matrix multiplications and nonlinear activation functions, without requiring per-property retraining or iterative optimization, the method 300 can be performed in real time as valuation requests are received.

### Crowdsourced Attribute Discovery

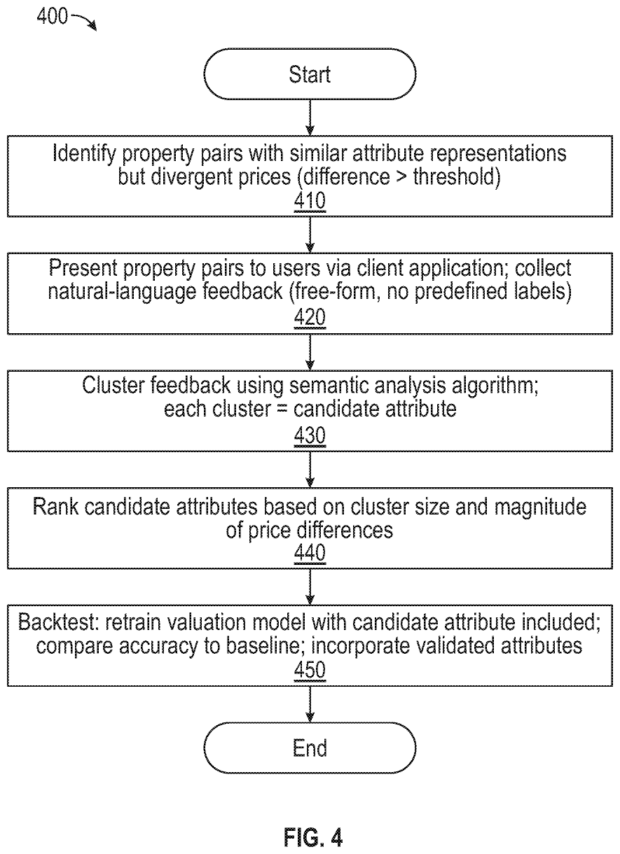

Referring now to FIG. 4, a method 400 for discovering new property attributes through crowdsourced feedback is illustrated. The method leverages user expertise to identify attributes that influence property value but are not present in standard real estate data sources. This attribute discovery process enables the system to expand its understanding of what drives property value over time.

At step 410, the system identifies two or more properties that have similar attributes but different user estimates or different actual sales prices. The identification of such property pairs leverages numeric property representations as a measure of property similarity. In some embodiments, similarity is computed using Euclidean distance or cosine similarity on the property attribute vectors or on learned property representations. Properties are selected when attribute similarity is high but price divergence exceeds a threshold amount. The existence of such pairs suggests that there are factors affecting value that are not captured by the current attribute set.

At step 420, the system presents the identified property pairs to one or more users through the client application and collects feedback. The user is prompted to explain why they estimated different prices for properties that appear similar, or why properties that appear similar sold for different prices. The system receives feedback from the user as free-form natural language without requiring selection from predefined attribute labels. This is a deliberate design choice: by not constraining the user's response to predetermined categories, the system enables discovery of attributes that were not anticipated by the system designer. For example, a user might explain that one property is in a flood-prone area, or that the neighborhood across the street has deteriorated, factors that would not be surfaced by a closed-ended questionnaire.

At step 430, the system groups similar feedback responses to identify common themes representing candidate attributes. The system aggregates feedback from multiple users and applies a topic modeling or clustering algorithm to identify semantic clusters representing similar explanations. In preferred embodiments, the system uses a BERTopic model, which encodes feedback text using transformer-based language model representations to create an explanation vector x_i for each explanation. Clustering is applied to group semantically similar feedback, using standard clustering algorithms (DBSCAN or K-means clustering). Each cluster represents a candidate attribute. In other embodiments, other natural language processing techniques suitable for identifying themes in text data may be used.

The output of step 430 is list of candidate attributes, each of which is a cluster of similar explanation items. Each explanation additionally is assigned a score indicating how similar each explanation is to the median explanation in that cluster. This is computed by the similarity between the vector representation of each explanation x_i and the mean vector representation of all explanations in the cluster, m_i.

At step 440, the candidate attributes are ranked based on two factors: how frequently they are mentioned (cluster size) and how large of a price difference they are associated with (magnitude of estimate or sales price differences for the property pairs that generated the feedback).

At step 450, each high-ranking candidate attribute is evaluated through backtesting: the valuation model is retrained with the candidate attribute included and prediction accuracy is compared to a baseline model without the attribute. Candidate attributes that improve prediction accuracy by more than a threshold amount are incorporated into the property attribute schema for use in future valuations.

In some embodiments, once a candidate attribute is validated, the system implements a process to compute the attribute for properties going forward. The computation process is selected based on the nature of the attribute and may comprise at least one of: an image analysis process using computer vision for visual attributes, integration with external data sources for data-derived attributes, or collection of user assessments for subjective attributes.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A computer-implemented method of estimating a sales price of a real estate property using a machine learning model, the method comprising:
receiving one or more property attributes for a real estate property, wherein the property attributes include property attributes obtained from a real estate data feed;
receiving one or more contextual attributes for a real estate property, wherein the contextual property attributes include attributes that affect property value but do not describe a measurable physical feature of the real estate property;
receiving user price estimates for the property from a plurality of users;
computing a property representation by applying a machine learning transformation to the property attributes and contextual attributes, wherein the machine learning transformation comprises at least a weight matrix multiplication;
retrieving a stored user representation for each user, wherein each user representation encodes that user's historical estimation patterns learned from training data comprising prior user estimates and corresponding actual sales prices;
computing a weight for each user by comparing a query derived from the property representation to keys derived from the user representations and user price estimates, and normalizing the comparison results such that the weights sum to one;
computing an adjusted value for each user by applying a transformation to a combination of that user's representation, that user's price estimate, and the property representation, wherein the incorporation of the property representation into the value computation enables property-specific adjustment of user estimates;
computing a combined estimate by weighting the adjusted values according to the computed weights; and
outputting an estimated sales price based on the combined estimate.

2. The method of claim 1, further comprising:
identifying two or more real estate properties having similar property representations but divergent prices;
receiving descriptive feedback in natural language from one or more users explaining the price differences;
clustering the received feedback to identify a candidate attribute;
validating the candidate attribute by retraining the machine learning model with the candidate attribute included and determining that prediction accuracy improves; and
incorporating the validated candidate attribute into the property attributes used in the step of receiving one or more property attributes for a real estate property, for subsequent property valuations, such that the machine learning model improves over time as new attributes are discovered and incorporated.

3. The method of claim 1, wherein the contextual attributes are derived from a data collection process comprising:
providing a form to a property seller or agent, wherein the form comprises fields for contextual attributes associated with the property;
receiving reported contextual attributes via the form;
incorporating the contextual attributes into the attributes used to compute a property representation.

4. The method of claim 1, wherein computing an adjusted value for each user comprises applying a multi-layer transformation with a nonlinear activation function between the layers, wherein the multi-layer transformation enables the model to learn nonlinear, property-dependent corrections to user estimates.

5. The method of claim 1, wherein the combination of that user's representation, that user's price estimate, and the property representation comprises a concatenation of these values.

6. The method of claim 1, wherein comparing the query to the keys comprises computing dot products between the query and the keys, scaling the dot products, and normalizing using a softmax function.

7. The method of claim 1, further comprising preprocessing the property attributes by standardizing continuous attributes and encoding categorical attributes into a numeric format.

8. The method of claim 1, wherein the stored user representations are learned during a training process comprising:
receiving training data comprising property attributes, contextual attributes, user estimates, and actual sales prices;
computing predicted sales prices using the machine learning model;
computing a loss measuring the difference between the predicted sales prices and the actual sales prices;
computing gradients of the loss with respect to model parameters via backpropagation; and
adjusting the model parameters to reduce the loss.

9. The method of claim 1, wherein the computed weights provide robustness to unreliable or adversarial user estimates, such that a user whose historical estimates systematically deviate from actual sales prices receives lower weights across properties as a consequence of the learned user representation, without requiring explicit outlier filtering rules.

10. The method of claim 1, further comprising computing an attribute-specific user expertise score for each user by aggregating the attention weights for that user across properties sharing a selected attribute, thereby identifying users who have demonstrated estimation accuracy for a specific property type, geographic area, or price range.

11. The method of claim 1, wherein, for a user who has not provided a sufficient number of prior estimates to learn an accurate user representation, the stored user representation comprises a default representation derived from representations of other users.

12. A system for estimating real estate property values using a machine learning model with property-dependent user weighting, the system comprising:
one or more processors;
a memory storing a learned user representation data structure and instructions that, when executed by the one or more processors, cause the system to:
receive a one or more property attribute vector comprising a plurality of attributes associated with a real estate property, including property attributes obtained from a real estate data feed and contextual attributes representing factors that are not obtained from a real estate data feed but correlate with property value;
receive one or more user price estimates for the real estate property from one or more users;
compute a property representation by transforming the property attribute vector using a machine learning model comprising at least a weight matrix multiplication;
retrieve a user representation for each user from a learned user representation data structure;
compute weights for the user price estimates using a weighting mechanism that compares a query derived from the property representation to keys derived from user representations and user price estimates;
compute adjusted user values by applying a transformation to combinations of user representations, user price estimates, and the property representation, thereby enabling property-specific adjustment of user estimates that accounts for learned user biases for particular property types;
compute an aggregated estimate by weighting the adjusted user values according to the computed weights; and
compute an estimated sales price based on the aggregated estimate and the property representation.

13. The system of claim 12, further comprising a database storing property data obtained from a real estate data feed, contextual attribute data obtained from one or more additional data sources, user data, and historical estimate data used to train the learned user representation data structure.

14. The system of claim 12, wherein the weighting mechanism is an attention mechanism and the transformation for computing adjusted user values comprises a multi-layer neural network transformation with a nonlinear activation function between layers.

15. A computer-implemented method of discovering real estate property attributes that affect sales price, comprising:
identifying, by one or more processors, two or more real estate properties having similar attribute representations according to a similarity metric and having divergent prices;
presenting, by the one or more processors, the two or more real estate properties to one or more users and receiving descriptive feedback in natural language explaining the price differences, wherein the feedback is collected without requiring selection from predefined attribute labels;
clustering, by the one or more processors, the received feedback using a semantic analysis algorithm into clusters, wherein each cluster represents a candidate attribute;
ranking, by the one or more processors, the candidate attributes based on at least cluster size and magnitude of price differences associated with each candidate attribute; and
for one or more candidate attributes, performing, by the one or more processors, backtesting by retraining a valuation model with the candidate attribute included and comparing prediction accuracy to a baseline model without the candidate attribute.

16. The method of claim 15, wherein clustering the feedback comprises generating numeric representations of the feedback text using a language model, and grouping similar representations using a clustering algorithm.

17. The method of claim 15, further comprising, for a candidate attribute that improves prediction accuracy by more than a threshold amount in the backtesting, adding the candidate attribute to a property attribute schema such that the attribute is included in property attribute vectors used for future property valuations.

18. The method of claim 15, wherein the divergent prices comprise divergent user estimates from a common user, divergent actual sales prices, or both.
